(19) United States
(12) Patent Application Publication
(10) Pub. No.: US 2007/0103135 A1
(43) Pub. Date: May 10, 2007

(54) Power supply apparatus with discharging switching element operated by one-shot pulse signal

(75) Inventor: Masahiro Ito, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 11/592,986

(22) Filed: Nov. 6, 2006

(30) Foreign Application Priority Data
Nov. 7, 2005 (JP) 2005-321729

(51) Int. Cl. G05F 1/00

(52) U.S. Cl. 323/282

(57) ABSTRACT

In a power supply apparatus, a power supply voltage generating circuit generates a power supply voltage and transmits it to an output terminal, and a discharging switching element is connected between the output terminal and a ground terminal. The discharging switching element is turned ON by a one-shot pulse signal.

### BACKGROUND OF THE INVENTION

1. Field of the Invention

The present invention relates to a power supply apparatus with a discharging switching element.

2. Description of the Related Art

Generally, a power supply apparatus is connected via a stabilizing capacitor to a load such as an integrated circuit unit. Therefore, when the power supply apparatus is deactivated, the output voltage of the power supply apparatus does not fall rapidly due to the presence of the stabilizing capacitor, which would invite a malfunction of the load.

In order to rapidly decrease the output voltage of the power supply apparatus when the power supply apparatus is deactivated, a discharging switching element is included and connected between the output of the power supply apparatus and the ground (see: JP-1-303048-A).

In a prior art power supply apparatus incorporating such a discharging switching element, the discharging switching element is turned ON and OFF in accordance with a control signal for activating and deactivating the power supply apparatus. This will be explained later in detail.

### SUMMARY OF THE INVENTION

However, when a plurality of such power supply apparatuses are mounted on an electronic apparatus such as a mobile phone set, a mobile game set or the like, if the output of one of the power supply apparatuses is short-circuited to the output of another power supply apparatus, an excessive discharging current may flow through the discharging switching element of one of the power supply apparatus, to destroy this discharging switching element. As a result, when the discharging switching element is destroyed, the entire power supply apparatus including this discharging switching element has to be replaced by another one in addition to the repair of the short-circuited state. This would increase the manufacturing cost of the electronic apparatus.

According to the present invention, in a power supply apparatus, a power supply voltage generating circuit generates a power supply voltage and transmits it to an output terminal, and a discharging switching element is connected between the output terminal and a ground terminal. The discharging switching element is turned ON by a one-shot pulse signal. Thus, if such an one-shot pulse signal is generated in accordance with a control signal for activating and deactivating the power supply voltage generating circuit, the discharging switching element is turned ON only for a certain time period determined by the one-shot pulse signal.

### BRIEF DESCRIPTION OF THE DRAWINGS

The present invention will be more clearly understood from the description set forth below, as compared with the prior art, with reference to the accompanying drawings, wherein:

FIG. 1 is a block circuit diagram illustrating an electronic apparatus such as a mobile phone set, a mobile game set or the like;

FIG. 2 is a circuit diagram illustrating a prior art power supply apparatus;

FIG. 3 is a timing diagram for explaining the test operation of the electronic apparatus of FIG. 1 where the power supply apparatus of FIG. 2 is applied to the power supply units;

FIG. 4 is a circuit diagram illustrating a first embodiment of the power supply apparatus according to the present invention;

FIG. 5 is a timing diagram for explaining the test operation of the electronic apparatus of FIG. 1 where the power supply apparatus of FIG. 4 is applied to the power supply units;

FIG. 6 is a detailed circuit diagram of the one-shot multivibrator of FIG. 4;

FIG. 7 is a timing diagram for explaining the operation of the one-shot multivibrator of FIG. 6;

FIG. 8 is a circuit diagram illustrating a second embodiment of the power supply apparatus according to the present invention;

FIG. 9 is a timing diagram for explaining the test operation of the electronic apparatus of FIG. 1 where the power supply apparatus of FIG. 8 is applied to the power supply units; and

FIGS. 10 and 11 are circuit diagrams illustrating modifications of the power supply apparatus of FIGS. 4 and 8, respectively.

### DESCRIPTION OF THE PREFERRED EMBODIMENTS

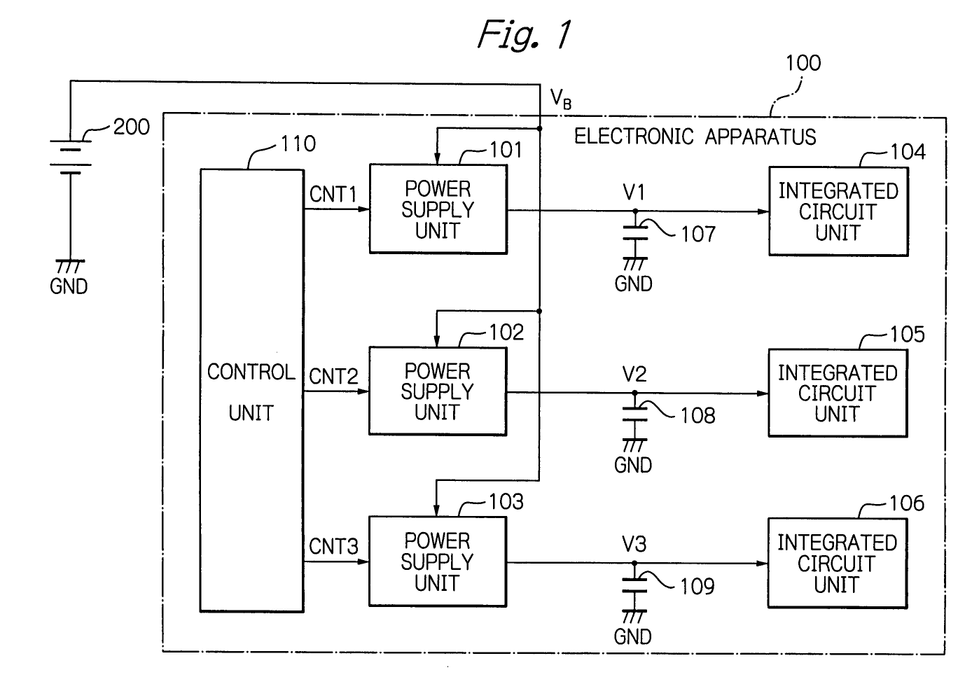

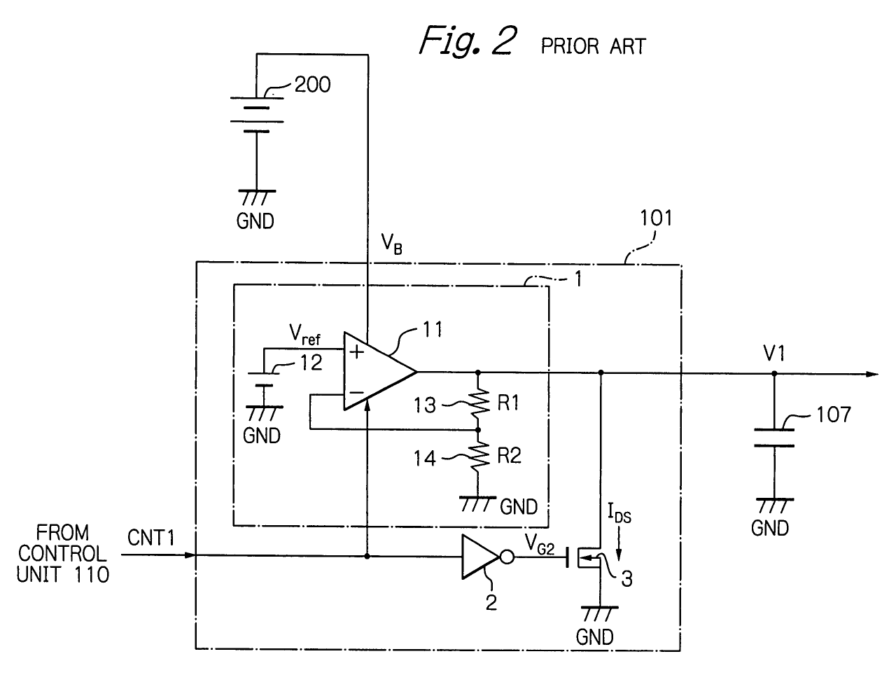

Before the description of the preferred embodiments, a prior art power supply apparatus will be explained with reference to FIGS. 1 and 2.

In FIG. 1, which illustrates an electronic apparatus 100 such as a mobile phone set, a mobile game set or the like, three power supply units 101, 102 and 103 are supplied with a battery voltage V_{B} such as 3.7V from a battery 200 to generate power supply voltages V1, V2 and V3 such as 2V, 2.5V and 3.0V which are supplied to integrated circuit units 104, 105 and 106, respectively. Also, stabilizing capacitors 107, 108 and 109 are connected to the outputs of the power supply units 101, 102 and 103, respectively. The power supply units 101, 102 and 103 are turned ON and OFF by control signals CNT1, CNT2 and CNT3, respectively, from a control unit 110 formed by a microcomputer.

FIG. 2 illustrates a prior art power supply apparatus applied to one of the power supply units such as 101 of FIG. 1.

The power supply apparatus of FIG. 2 is constructed by a power supply voltage generating circuit 1 powered by battery voltage V_{B}, an inverter 2 and a discharging n-channel MOS transistor 3. The power supply voltage generating circuit 1 is turned ON and OFF by the control signal CNT1 from the control unit 110 of FIG. 1 which is also supplied to the inverter 2 to turn ON and OFF the discharging n-channel MOS transistor 3.

Also, the power supply voltage generating circuit 1 is constructed by an operational amplifier 11 powered by the battery voltage V_{B}, a reference voltage generating circuit 12 formed by a bandgap regulator or the like for generating a reference voltage V_{ref}, a voltage divider formed by resistors 13 and 14. As a result, when the power supply voltage generating circuit 1 is turned ON by the control signal CNT1 of the control unit 110, the power supply voltage generating circuit 1 generates an output voltage Vₒᵤₜ₁, at an output terminal OUT defined by
Vₒᵤₜ₁=V_{ref}·(R1+R2)/R2

where R1 and R2 are resistance values of the resistors 13 and 14, respectively. Note that the operational amplifier 11 incorporates a switch element for receiving the control signal CNT1, so that the operational amplifier 11 is activated or deactivated by turning ON or OFF this switch element. Thus, the output voltage Vₒᵤₜ₁ can easily be set by the resistance values R1 and R2 of the resistors 13 and 14.

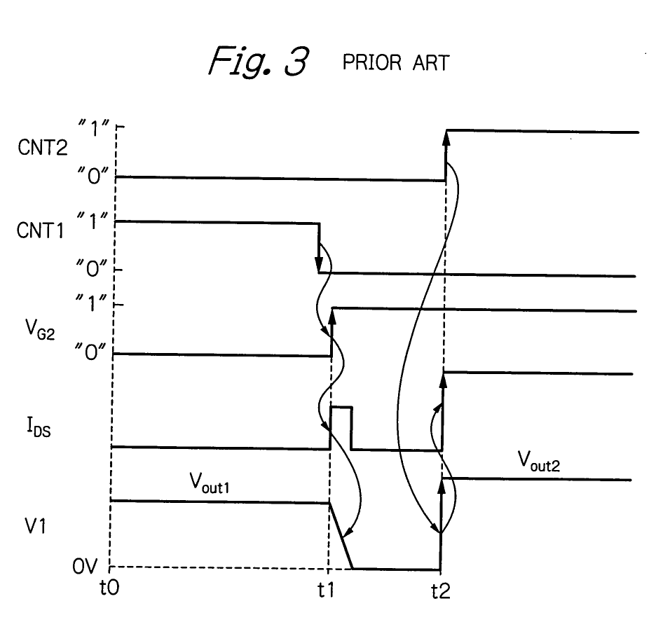

The test operation of the electronic apparatus of FIG. 1 where the power supply apparatus of FIG. 2 is applied to the power supply units 101, 102 and 103 will be explained next with reference to FIG. 3. Here, assume that the output of the power supply unit 102 is short-circuited to the output of the power supply unit 101.

Initially, at time t0, when the control signal CNT1 is “1” (high level), the power supply voltage V1 of the power supply voltage generating circuit 1 equals the voltage Vₒᵤₜ₁. Also, the gate voltage V_{G2} of the discharging n-channel MOS transistor 3 is “0” (low level), so that the discharging n-channel MOS transistor 3 is turned OFF. Thus, no discharging current I_{DS} flows through the discharging n-channel MOS transistor 3. Note that the control signal CNT2 is “0” (low level), which does not affect the power supply voltage V1 of the power supply unit 101.

Next, at time t1, the control signal CNT1 is switched from “1” (high level) to “0” (low level), so that the power supply voltage generating circuit 1 is deactivated to decrease the voltage V1 from V_{ref1} to the ground level GND. Simultaneously, the gate voltage V_{G2} of the discharging n-channel MOS transistor 3 is switched from “0” (low level) to “1” (high level) to turn ON the discharging n-channel MOS transistor 3. As a result, a discharging current I_{DS} flows through the discharging n-channel MOS transistor 3 for a certain time period, so that the charge stored at the capacitor 107 is rapidly discharged. Thus, the power supply voltage V1 of the power supply unit 101 is rapidly decreased from Vₒᵤₜ₁ to the ground level GND.

Finally, at time t2, when the control signal CNT2 is switched from “0” (low level) to “1” (high level) to turn ON the power supply unit 102, since the output of the power supply unit 102 is short-circuited to the output of the power supply unit 101, the power supply voltage V1 of the power supply unit 101 is also rapidly increased from the ground level GND to a voltage Vₒᵤₜ₂ determined by the power supply voltage generating circuit (not shown) of the power supply unit 102. As a result, a discharging current I_{DS} flows through the discharging n-channel MOS transistor 3 due to the high level state of the gate voltage V_{G2} thereof. In this case, the higher the voltage Vₒᵤₜ₂ of the power supply unit 102, the larger the discharging current I_{DS}. Therefore, at worst, the discharging n-channel MOS transistor 3 would be destroyed.

When the discharging n-channel MOS transistor 3 is destroyed, the entire power supply unit 101 has to be replaced by another one in addition to the repair of the short-circuited state. This would increase the manufacturing cost of the electronic apparatus of FIG. 1.

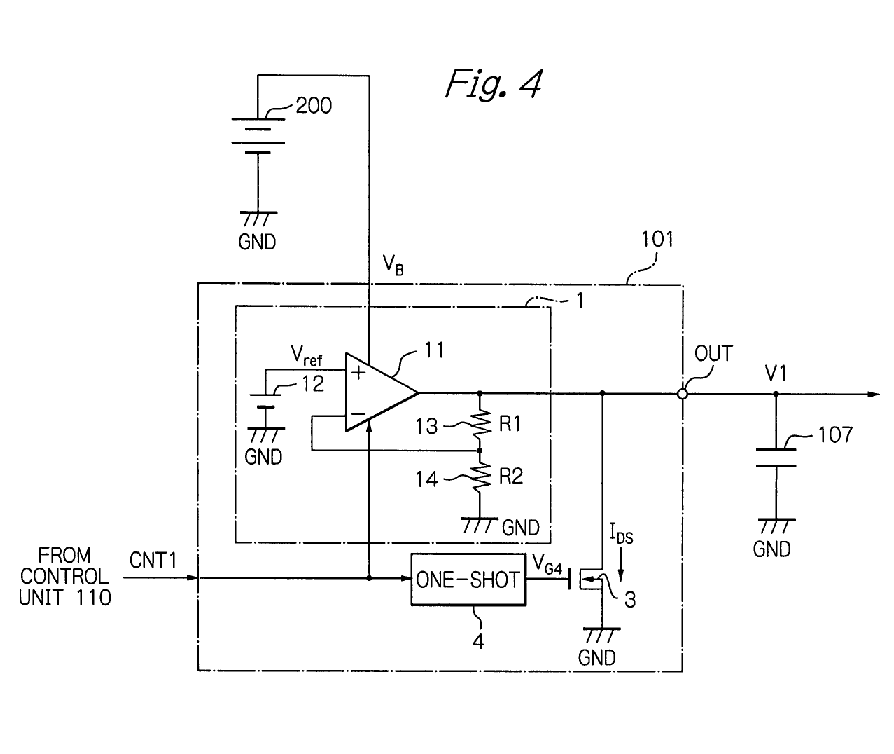

FIG. 4 illustrates a first embodiment of the power supply apparatus according to the present invention applied to one of the power supply units such as 101 of FIG. 1. In FIG. 4, the inverter 2 of FIG. 2 is replaced by a one-shot multivibrator 4 which receives a falling edge of the control signal CNT1 to generate a one-shot pulse signal having a time period t_{d}.

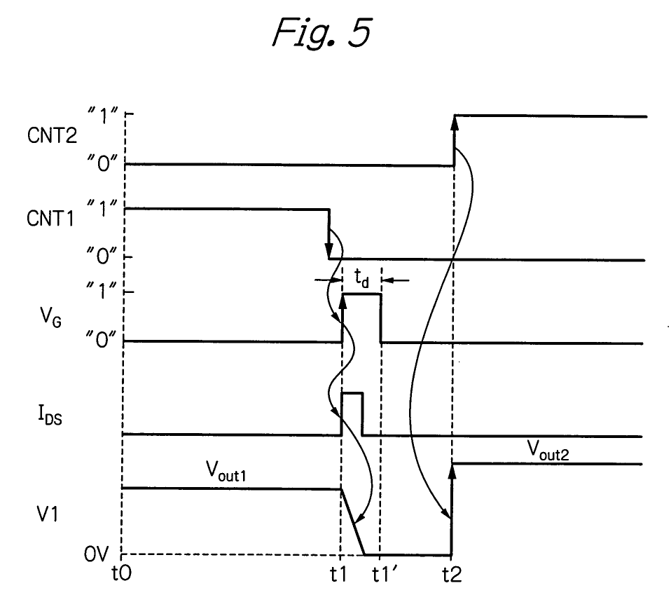

The test operation of the electronic apparatus of FIG. 1 where the power supply apparatus of FIG. 4 is applied to the power supply units 101, 102 and 103 will be explained next with reference to FIG. 5. Here, also assume that the output of the power supply unit 102 is short-circuited to the output of the power supply unit 101.

Initially, at time t0, when the control signal CNT1 is “1” (high level), the power supply voltage V1 of the power supply voltage generating circuit 1 equals the voltage Vₒᵤₜ₁. Also, the gate voltage V_{G4} of the discharging n-channel MOS transistor 3 is “0” (low level), so that the discharging n-channel MOS transistor 3 is turned OFF. Thus, no discharging current I_{DS} flows through the discharging n-channel MOS transistor 3. Note that the control signal CNT2 is “0” (low level), which does not affect the power supply voltage V1 of the power supply unit 101.

Next, at time t1, the control signal CNT1 is switched from “1” (high level) to “0” (low level), so that the power supply voltage generating circuit 1 is deactivated to decrease the voltage V1 from V_{ref1} to the ground level GND. Simultaneously, the one-shot multivibrator 4 generates a one-shot pulse signal having the time period t_{d} which is supplied as a gate voltage V_{G4} to the discharging n-channel MOS transistor 3 to turn ON the discharging n-channel MOS transistor 3. As a result, a discharging current I_{DS} flows through the discharging n-channel MOS transistor 3 for a certain time period, so that the charge stored at the capacitor 107 is rapidly discharged. Thus, the power supply voltage V1 of the power supply unit 101 is rapidly decreased from Vₒᵤₜ₁ to the ground level GND. In this case, at time t1′ (=t1+t_{d}), the gate voltage V_{G4} returns to “0” (low level).

Finally, at time t2 after time t1′, when the control signal CNT2 is switched from “0” (low level) to “1” (high level) to turn ON the power supply unit 102, since the output of the power supply unit 102 is short-circuited to the output of the power supply unit 101, the power supply voltage V1 of the power supply unit 101 is also rapidly increased from the ground level GND to a voltage Vₒᵤₜ₂ determined by the power supply voltage generating circuit (not shown) of the power supply unit 102. In this case, however, no discharging current I_{DS} flows through the discharging n-channel MOS transistor 3 due to the ground level state of the gate voltage V_{G4} thereof. Therefore, the discharging n-channel MOS transistor 3 would not be destroyed.

Note that, while the discharging n-channel MOS transistor 3 is turned OFF during a time period from t0 to t1, a part of the charge stored at the capacitor 107 flows through the resistors 13 and 14; however, the amount of the part of the charge is very small due to the relatively large resistance values R1 and R2 thereof.

Thus, in order to alleviate the electronic apparatus of FIG. 1, only the above-mentioned short-circuited state would be repaired. This would not increase the manufacturing cost of the electronic apparatus of FIG. 1.

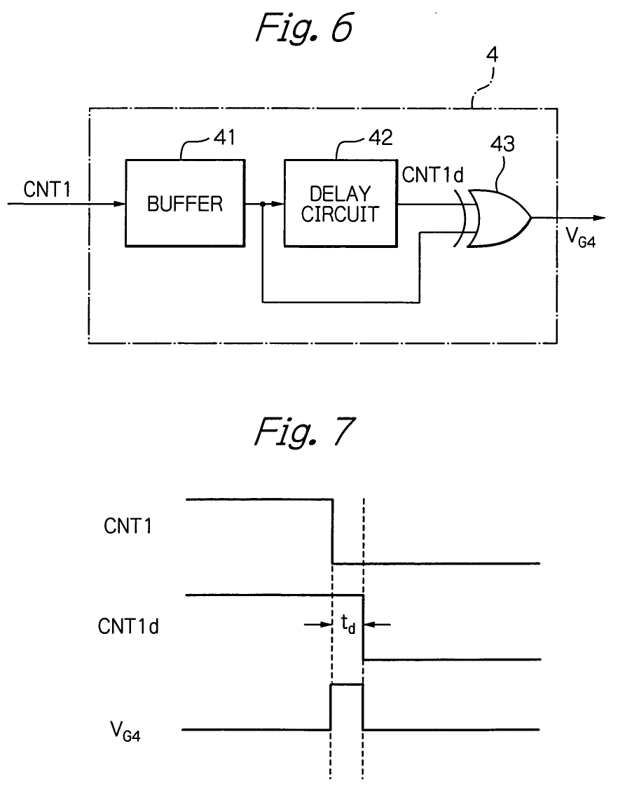

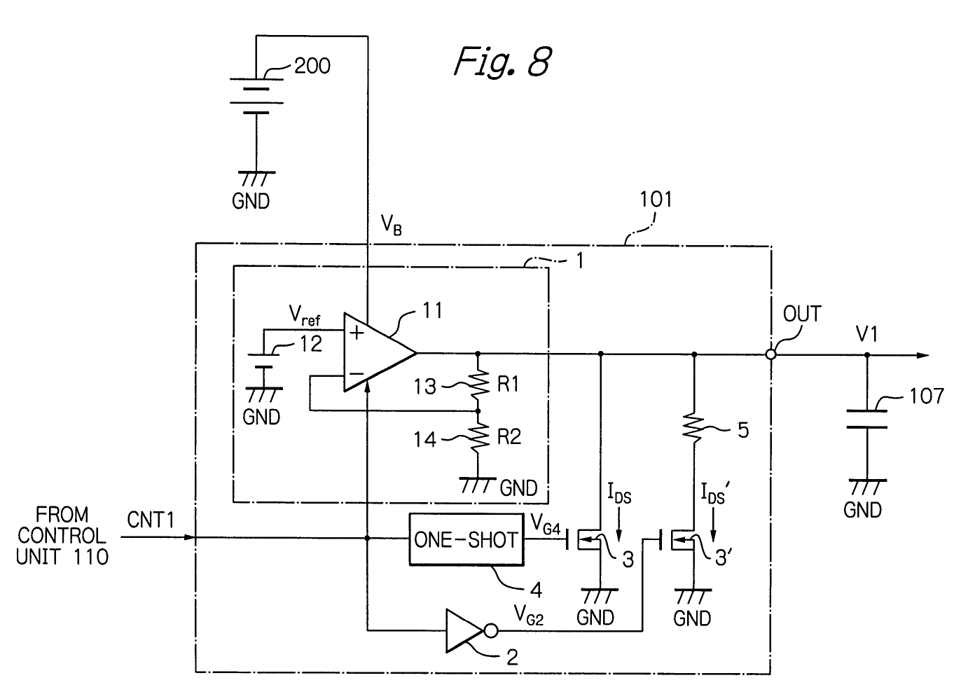

In FIG. 6, which is a detailed circuit diagram of the one-shot multivibrator 4 of FIG. 5, the one-shot multivibrator 4 is constructed by a buffer 41 for receiving the control signal CNT1 as shown in FIG. 7, a delay circuit 42 for delaying an output signal of the buffer 41 by a delay time t_{d} to generate an output signal CNT1d as shown in FIG. 7, and an exclusive OR circuit 43 for performing an exclusive OR operation upon the output of the buffer 41 and the output of the delay circuit 42 to generate the one-shot pulse signal V_{G4} as shown in FIG. 7.

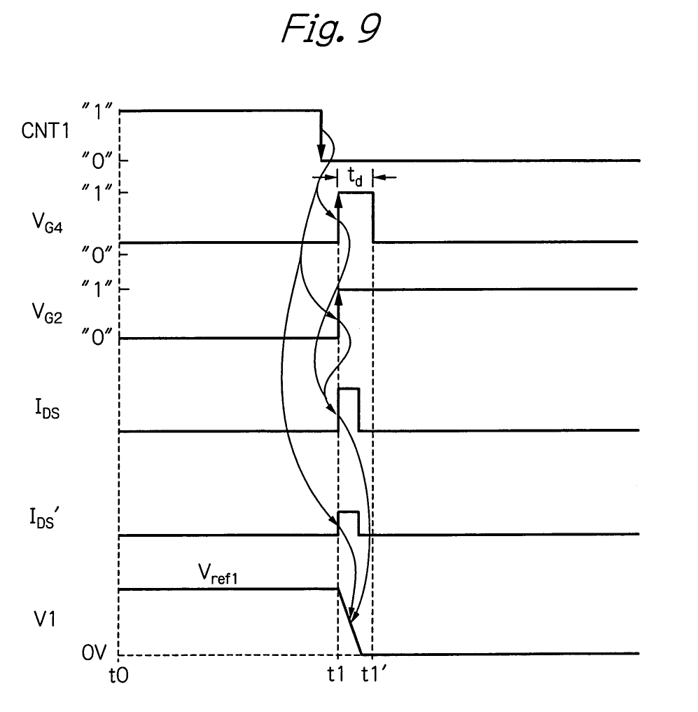

FIG. 8 illustrates a second embodiment of the power supply apparatus according to the present invention applied to one of the power supply units such as 101 of FIG. 1. In FIG. 8, the inverter 2 of FIG. 2 and a discharging n-channel MOS transistor 3′ are added to the elements of FIG. 4. In this case, the ON resistance value of the discharging n-channel MOS transistor 3′ is larger than that of the discharging n-channel MOS transistor 3. Also, a resistor 5 connected in series to the discharging n-channel MOS transistor 3′ further substantially increases the ON-resistance value thereof; however, the resistor 5 can be omitted.

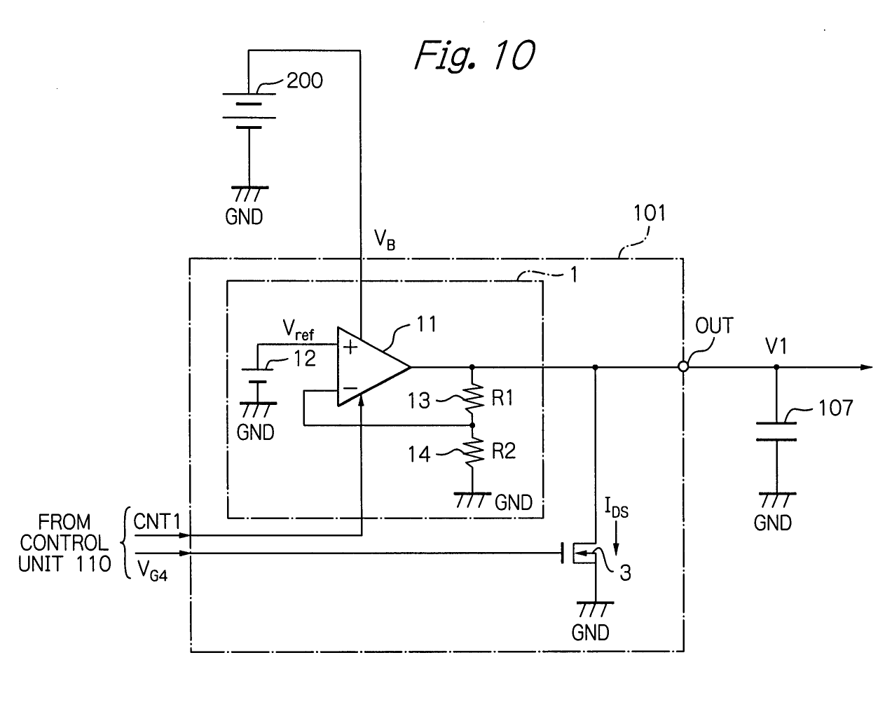

The test operation of the electronic apparatus of FIG. 1 where the power supply apparatus of FIG. 8 is applied to the power supply units 101, 102 and 103 will be explained with reference to FIG. 9. Here, assume that the output of the power supply unit 102 is not short-circuited to the output of the power supply unit 101. In this case, since the ON-resistance value of the discharging n-channel MOS transistor 3′ is larger than that of the discharging n-channel MOS transistor 3′, the discharging current I_{DS}′ after time t5 is so small that the discharging n-channel MOS transistor 3′ would not be destroyed.

The test operation of the electronic apparatus of FIG. 1 where the power supply apparatus of FIG. 9 is applied to the power supply units 101, 102 and 103 will be explained next with reference to FIG. 9. Here, assume that the output of the power supply unit 102 is not short-circuited to the output of the power supply unit 101.

Initially, at time t0, when the control signal CNT1 is “1” (high level), the power supply voltage V1 of the power supply voltage generating circuit 1 equals the voltage Vₒᵤₜ₁. Also, the gate voltage V_{G4} of the discharging n-channel MOS transistor 3 and the gate voltage V_{G2} of the discharging n-channel MOS transistor 3′ are “0” (low level), so that the discharging n-channel MOS transistors 3 and 3′ are turned OFF. Thus, no discharging currents I_{DS} and I_{DS}′ flow through the discharging n-channel MOS transistors 3 and 3′.

Next, at time t1, the control signal CNT1 is switched from “1” (high level) to “0” (low level), so that the power supply voltage generating circuit 1 is deactivated to decrease the voltage V1 from V_{ref1} to the ground level GND. Simultaneously, the one-shot multivibrator 4 generates a one-shot pulse signal having the time period t_{d} which is supplied as a gate voltage V_{G4} to the discharging n-channel MOS transistor 3 to turn ON the discharging n-channel MOS transistor 3. As a result, a discharging current I_{DS} flows through the discharging n-channel MOS transistor 3 for a certain time period, so that the charge stored at the capacitor 107 is rapidly discharged. Thus, the power supply voltage V1 of the power supply unit 101 is rapidly decreased from Vₒᵤₜ₁ to the ground level GND. In this case, at time t1′ (=t1+t_{d}), the gate voltage V_{G4} returns to “0” (low level).

Also, at time t1, the gate voltage V_{G2} is switched from “0” (low level) to “1” (high level), so that a discharging current I_{DS}′ flows through the discharging n-channel MOS transistor 3′, which also would contribute to the discharging operation of the capacitor 107. However, note that the discharging current I_{DS}′ is smaller than the discharging current I_{DS}′, since the ON-resistance of the discharging n-channel MOS transistor 3′ is larger than that of the discharging n-channel MOS transistor 3. Even after time t1′, the gate voltage V_{G2} remains at “1” (high level) so that the discharging n-channel MOS transistor 3′ keeps activated. Therefore, even after time t1′, the power supply voltage V1 is surely kept at the ground level GND.

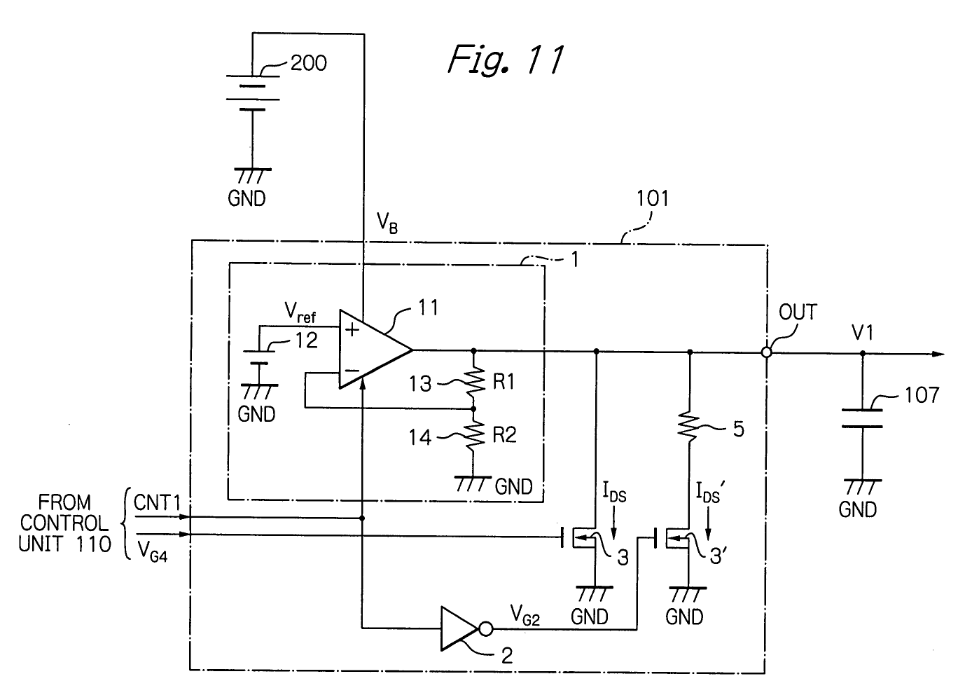

In FIGS. 10 and 11, which illustrate modifications of the power supply apparatuses of FIGS. 4 and 8, respectively, the one-shot multivibrator 4 is not provided. That is, the gate voltage V_{G4} is generated within the control unit 110 of FIG. 1 in synchronization with falling edges of the control signal CNT1 and is supplied directly to the discharging n-channel MOS transistor 3.

In the above-described embodiments, the discharging n-channel MOS transistors 3 and 3′ can be other switching elements such as npn-type bipolar transistors.

As explained hereinabove, according to the present invention, the destruction of discharging switching elements can be suppressed.

1. A power supply apparatus comprising:
an output terminal;
a power supply voltage generating circuit adapted to generate a power supply voltage and transmit it to said output terminal; and
a first discharging switching element connected between said output terminal and a ground terminal,
said first discharging switching element being turned ON by a one-shot pulse signal.

2. The power supply apparatus as set forth in claim 1, wherein said one-shot pulse signal is generated in response to a control signal for activating and deactivating said power supply voltage generating circuit.

3. The power supply apparatus as set forth in claim 2, further comprising a one-shot multivibrator adapted to receive said control signal to generate said one-shot pulse signal.

4. The power supply apparatus as set forth in claim 3, wherein said one-shot multivibrator comprises:
a buffer adapted to receive said control signal;
a delay circuit adapted to delay an output signal of said buffer; and
a logic circuit adapted to perform a logic operation upon the output signal of said buffer and an output signal of said delay circuit to generate said one-shot pulse signal.

5. The power supply apparatus as set forth in claim 4, wherein said logic operation is an exclusive OR logic operation.

6. The power supply apparatus as set forth in claim 1, further comprising a second discharging switching element connected between said output terminal and said ground terminal, said second discharging switching element being operated in response to said control signal.

7. The power supply apparatus as set forth in claim 6, wherein an ON-resistance value of said second discharging switching element is larger than an ON-resistance value of said first discharging switching element.

8. The power supply apparatus as set forth in claim 6, further comprising a resistor connected in series to said second discharging switching element.
